(19) United States
(12) Patent Application Publication
(10) Pub. No.: US 2025/0231857 A1
(43) Pub. Date: Jul. 17, 2025

(54) SYSTEMS, METHODS, AND NON-TRANSITORY COMPUTER READABLE MEDIUM FOR DETERMINING A MODEL HEALTH SCORE

(71) Applicant: Charles Schwab & Co., Inc, San Francisco, CA (US)

(72) Inventors: Tuan DO, Paramus, NJ (US); Mitchel WEILER, Omaha, NE (US)

(73) Assignee: Charles Schwab & Co., Inc, San Francisco, CA (US)

(21) Appl. No.: 18/989,772

(22) Filed: Dec. 20, 2024

Related U.S. Application Data
(60) Provisional application No. 63/619,794, filed on Jan. 11, 2024.

(51) Int. Cl. G06F 11/34; G06F 11/07; G06F 11/32

(52) U.S. Cl. CPC G06F 11/3447; G06F 11/079; G06F 11/321

(57) ABSTRACT

A system for generating a model health score includes a memory storing computer-executable instructions and a processor configured to execute the computer-executable instructions to cause the system to perform selecting a model of a plurality of models to analyze, selecting a prediction from a plurality of predictions where the selected model was executed, and determining a model health score for the selected model. The selected model includes a plurality of variables and the model health score is based on at least a subset of the plurality of variables. The model health score indicates viability of the selected model for the selected prediction.

### CROSS-REFERENCE TO RELATED APPLICATIONS

This application claims priority to U.S. Provisional Patent Application No. 63/619,794, filed Jan. 11, 2024. The entire disclosure of which is hereby incorporated by reference in its entirety.

### TECHNICAL FIELD

Various example embodiments relate to systems, methods, devices and/or non-transitory computer readable media for determining a model health score.

### BACKGROUND

The statements in this section merely provide background information related to example embodiments and may not constitute prior art.

Traditionally, models make predictions for the future. In general, models may only be evaluated for dependent variable performance after a threshold number of days of the model being in operation as determined by initial experimental design. For example, a model's prediction may not be evaluated for 90 days after it has been made. Modern systems in production lack an understanding of future performance at the time a prediction is made, lack a focused delivery of predictor level issues, and lack a means to stress test and understand performance decay. Runtime model performance decay detection provides a top-down simplification of future prediction viability and alerting with root cause identification at the time a prediction is made. Embodiments described herein provide a solution to the existing gaps in modern production systems.

### SUMMARY

At least one example embodiment describes a system for generating a model health score. The system may include a memory storing computer-executable instructions and a processor configured to execute the computer-executable instructions to cause the system to perform selecting a model of a plurality of models to analyze, selecting a prediction from a plurality of predictions where the selected model was executed, and determining a model health score for the selected model. The selected model may include a plurality of variables and the model health score may be based on at least a subset of the plurality of variables. The model health score may indicate viability of the selected prediction for the selected model.

In at least one example embodiment, the system may be further caused to perform determining whether expected performance of the selected model has started to decay based on the model health score and outputting an alert if the expected performance of the selected model has started to decay.

In at least one example embodiment, each variable of the plurality of variables may include an expected contribution percentage and an expected contribution index for the selected model. A sum of the expected contribution indexes of each variable of the plurality of variables may be an expected total contribution index. In at least one example embodiment, the expected contribution index may be determined by dividing the expected contribution percentage by an average contribution percentage for the plurality of variables. In at least one example embodiment, determining the model health score for the selected model may include for each variable of the variables with an expected contribution index above a threshold value, determining a drift score, setting a model health score contribution index of the variable as the expected contribution index if the drift score is below a drift score threshold, and setting the model health score contribution index of the variable to zero if the drift score is above the drift score threshold. Determining the model health score may additionally include determining a model health score total contribution index as a sum of the model health score contribution indexes and determining the model health score by dividing the model health score total contribution index by the expected total contribution index. In at least one example embodiment, the system may be further caused to perform obtaining model data for the model on the selected prediction, dividing the model data into one or more segments, and determining the drift score for each variable of the plurality of variables within each of the one or more segments. In at least one example embodiment, the system may be further caused to perform determining a variable health alert rank for each variable of the plurality of variables, and sorting the plurality of variables based on the variable health alert rank to determine a variable health rank, wherein the variable health rank indicates a root cause of the model health score. In at least one example embodiment, the variable health alert rank for a variable of the plurality of variables may be determined by determining a variable health index for the variable, determining a variable health index drift score for the variable, and determining a variable health alert rank for the variable based on the variable health index drift score of the variable and a variable health index drift score of each variable of the plurality of variables.

In at least one example embodiment, the system may be further caused to perform outputting a number of errors of the model on the selected prediction. The number or errors may correspond to a number of variables with a variable health below a variable health threshold. In at least one example embodiment, the system may be further caused to perform outputting a number of warnings of the model on the selected prediction. The variable health threshold may be a first threshold and the number or warnings corresponds to a number of variables with a variable health above a second threshold and below the first threshold. The first threshold may be greater than the second threshold.

In at least one example embodiment, the system may be further caused to perform outputting a first indication if the model health score drops below a first threshold, and outputting a second indication if the model health score drops below a second threshold, the second threshold being less than the first threshold.

In at least one example embodiment, the system may be further caused to perform generating an aggregate model health score based on the model health score of the selected prediction and a model health score and a lift health score of the selected model on one or more predictions within a range of the selected prediction.

In at least one example embodiment, the system may be further caused to perform generating a graphical user interface including at least one of the model health score, the model health score over a period of time, or performance information of the plurality of variables of the selected model.

At least one example embodiment describes a method for generating a model health score. The method may include selecting a model of a plurality of models to analyze, selecting a prediction from a plurality of predictions where the selected model was executed, and determining a model health score for the selected model. The selected model may include a plurality of variables and the model health score may be based on at least a subset of the plurality of variables. The model health score may indicate viability of the selected prediction for the selected model.

In at least one example embodiment, the methods may further include determining whether expected performance of the selected model has started to decay based on the model health score and outputting an alert if the expected performance of the selected model has started to decay.

In at least one example embodiment, each variable of the plurality of variables may include an expected contribution percentage and an expected contribution index for the selected model. A sum of the expected contribution indexes of each variable of the plurality of variables may be an expected total contribution index. In at least one example embodiment, the expected contribution index may be determined by dividing the expected contribution percentage by an average contribution percentage for the plurality of variables. In at least one example embodiment, determining the model health score for the selected model may include for each variable of the variables with an expected contribution index above a threshold value, determining a drift score, setting a model health score contribution index of the variable as the expected contribution index if the drift score is below a drift score threshold, and setting the model health score contribution index of the variable to zero if the drift score is above the drift score threshold. Determining the model health score may additionally include determining a model health score total contribution index as a sum of the model health score contribution indexes and determining the model health score by dividing the model health score total contribution index by the expected total contribution index. In at least one example embodiment, the method may further include obtaining model data for the model on the selected prediction, dividing the model data into one or more segments, and determining the drift score for each variable of the plurality of variables within each of the one or more segments. In at least one example embodiment, the method may further include determining a variable health alert rank for each variable of the plurality of variables, and sorting the plurality of variables based on the variable health alert rank to determine a variable health rank, wherein the variable health rank indicates a root cause of the model health score. In at least one example embodiment, the variable health alert rank for a variable of the plurality of variables may be determined by determining a variable health index for the variable, determining a variable health index drift score for the variable, and determining a variable health alert rank for the variable based on the variable health index drift score of the variable and a variable health index drift score of each variable of the plurality of variables.

In at least one example embodiment, the method may further include outputting a number of errors of the model on the selected prediction. The number or errors may correspond to a number of variables with a variable health below a variable health threshold. In at least one example embodiment, the method may further include outputting a number of warnings of the model on the selected prediction. The variable health threshold may be a first threshold and the number or warnings corresponds to a number of variables with a variable health above a second threshold and below the first threshold. The first threshold may be greater than the second threshold.

In at least one example embodiment, the method may further include outputting a first indication if the model health score drops below a first threshold, and outputting a second indication if the model health score drops below a second threshold, the second threshold being less than the first threshold.

In at least one example embodiment, the method may further include generating an aggregate model health score based on the model health score of the selected prediction and a model health score and a lift health score of the selected model on one or more predictions within a range of the selected prediction.

In at least one example embodiment, the method may further include generating a graphical user interface including at least one of the model health score, the model health score over a period of time, or performance information of the plurality of variables of the selected model.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The accompanying drawings, which are incorporated in and constitute a part of the specification, illustrate one or more example embodiments and, together with the description, explain these example embodiments. In the drawings:

FIG. 1 is a device configured to determine a model health score according to an example embodiment.

FIG. 2 is a flow chart of a method of determining a model health score according to an example embodiment.

FIG. 3 is a flow chart of an example embodiment of a method of calculating the model health score at S215 of FIG. 2.

FIG. 4 is a flow chart of a method of determining a variable health alert rank according to an example embodiment.

FIG. 5 is an illustration of a generative artificial intelligence system according to an example embodiment.

FIG. 6 is a flow chart of a method performed by an image recognition model according to an example embodiment.

FIG. 7 is a GUI including details of a series of predictions of a selected model according to an example embodiment.

FIG. 8 is a GUI including details of a first selected prediction of a selected model according to an example embodiment.

FIG. 9 is a GUI including details of a second selected prediction of a selected model according to an example embodiment.

FIG. 10 is a GUI including variable level details of the first selected prediction of the selected model of FIG. 8 according to an example embodiment.

FIG. 11 is a GUI including variable level details of the first selected prediction of the selected model of FIG. 9 according to an example embodiment.

FIG. 12 is a block diagram of an of an alerting diagram according to an example embodiment.

FIG. 13 is a flow chart of a method of a response operation based on an alert search being executed according to an example embodiment.

### DETAILED DESCRIPTION

Various example embodiments will now be described more fully with reference to the accompanying drawings in which some example embodiments are shown.

Detailed example embodiments are disclosed herein. However, specific structural and functional details disclosed herein are merely representative for purposes of describing the example embodiments. The example embodiments may, however, may be embodied in many alternate forms and should not be construed as limited to only the example embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the example embodiments. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular example embodiments only and is not intended to be limiting of the example embodiments. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the following description to provide a thorough understanding of the example embodiments. However, it will be understood by one of ordinary skill in the art that example embodiments may be practiced without these specific details. For example, systems may be shown in block diagrams in order not to obscure the example embodiments in unnecessary detail. In other instances, well-known processes, structures and techniques may be shown without unnecessary detail in order to avoid obscuring example embodiments.

Also, it is noted that example embodiments may be described as a process depicted as a flowchart, a flow diagram, a data flow diagram, a structure diagram, or a block diagram. Although a flowchart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, a function, a procedure, a subroutine, a subprogram, etc. When a process corresponds to a function, its termination may correspond to a return of the function to the calling function or the main function.

Moreover, as disclosed herein, the term “memory” may represent one or more devices for storing data, including random access memory (RAM), magnetic RAM, core memory, and/or other machine readable mediums for storing information. The term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” may include, but is not limited to, portable or fixed storage devices, optical storage devices, wireless channels, and various other mediums capable of storing, containing or carrying instruction(s) and/or data.

Furthermore, example embodiments may be implemented by hardware circuitry and/or software, firmware, middleware, microcode, hardware description languages, etc., in combination with hardware (e.g., software executed by hardware, etc.). When implemented in software, firmware, middleware or microcode, the program code or code segments to perform the desired tasks may be stored in a machine or computer readable medium such as a non-transitory computer storage medium, and loaded onto one or more processors to perform the desired tasks.

A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

As used in this application, the term “circuitry” and/or “hardware circuitry” may refer to one or more or all of the following: (a) hardware-only circuit implementation (such as implementations in only analog and/or digital circuitry); (b) combinations of hardware circuits and software, such as (as applicable): (i) a combination of analog and/or digital hardware circuit(s) with software/firmware, and (ii) any portions of hardware processor(s) with software (including digital signal processor(s)), software, and memory(ies) that work together to cause an apparatus, such as a mobile phone, a smart device, and/or server, etc., to perform various functions); and (c) hardware circuit(s) and/or processor(s), such as microprocessor(s) or a portion of a microprocessor(s), that requires software (e.g., firmware) for operation, but the software may not be present when it is not needed for operation. For example, the circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

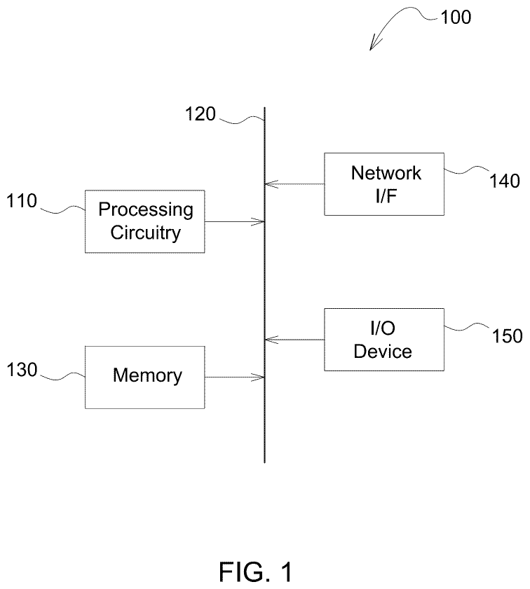

FIG. 1 illustrates a device configured to obfuscate text data according to example embodiments.

Referring to FIG. 1, a device 100 configured to obfuscate text data may include processing circuitry 110 such as at least one processor, at least one communication bus 120, a memory 130, at least one network interface (I/F) 140, and/or at least one input/output (I/O) device 150 (e.g., a keyboard, a monitor, a touchscreen, a mouse, a microphone, a camera, a speaker, etc.), etc., but the example embodiments are not limited thereto.

The memory 130 may include various special purpose program code including computer executable instructions which may cause the device 100 to perform one or more of the methods of the example embodiments, including but not limited to obfuscating text data by tokenizing words in a data source and comparing the tokenized words to a list of allowed words.

In at least one example embodiment, the processing circuitry 110 may include processor cores, distributed processors, or networked processors. The processing circuitry 110 may be configured to control one or more elements of the device 100, and thereby cause the device 100 to perform various operations. The processing circuitry 110 is configured to execute processes by retrieving program code (e.g., computer readable instructions) and data from the memory 130 to process them, thereby executing special purpose control and functions of the entire device 100. Once the special purpose program instructions are loaded into, (e.g., the at least one processor), the processing circuitry 110 executes the special purpose program instructions, thereby transforming the processing circuitry 110 into a special purpose processor.

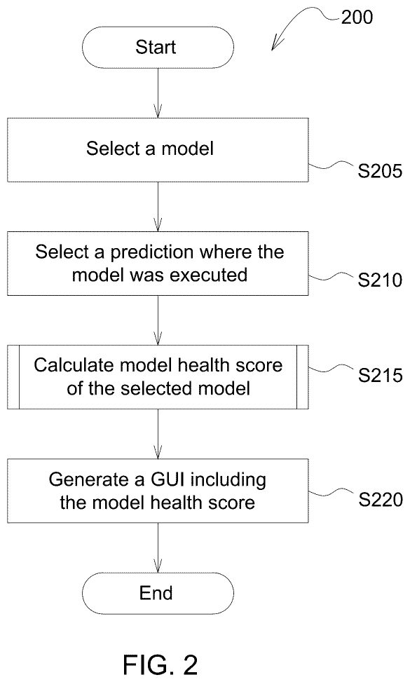

In at least one example embodiment, the memory 130 may be a non-transitory computer-readable storage medium and may include a random access memory (RAM), a read only memory (ROM), and/or a permanent mass storage device such as a disk drive, or a solid-state drive. Stored in the memory 130 is program code (i.e., computer readable instructions) related to determining a model health score as the methods discussed in connection with FIG. 2, and controlling the at least one network interface 140, and/or at least one I/O device 150, etc.

Such software elements may be loaded from a non-transitory computer-readable storage medium independent of the memory 130, using a drive mechanism (not shown) connected to the device 100, or via the at least one network interface 140, and/or at least one I/O device 150, etc.

In at least one example embodiment, the at least one communication bus 120 may enable communication and/or data transmission to be performed between elements of the device 100. The communication bus 120 may be implemented using a high-speed serial bus, a parallel bus, and/or any other appropriate communication technology. According to some example embodiments, the device 100 may include a plurality of communication buses (not shown).

While FIG. 1 depicts an example embodiment of the device 100, the device 100 is not limited thereto, and may include additional and/or alternative architectures that may be suitable for the purposes demonstrated. For example, the functionality of the device 100 may be divided among a plurality of physical, logical, and/or virtual server and/or computing devices, network elements, etc. The embodiments described herein may be described with reference to the embodiment of FIG. 1 although the embodiments herein are not limited to the embodiment of FIG. 1.

FIG. 2 is a flow chart of a method 200 of determining a model health score.

The method 200 may begin at step S205 where a model is selected. A model may be selected by a user who wants to view performance metrics of a model after a prediction of the model. As used herein, a prediction of a model may describe a single run of the model on a set of data. A model may include a plurality of variables. At least a subset of the plurality of variables may be used to determine a model health score for the selected model.

After a model is selected, at step S210, a prediction may be selected. In at least one example embodiment, there may be a plurality of predictions of the model and a user may select a single prediction to analyze. In other example embodiments, a series of predictions or days of predictions of a model may be selected such that an aggregate model health score may be determined. Additional details of an aggregate model health score will be described in further detail herein.

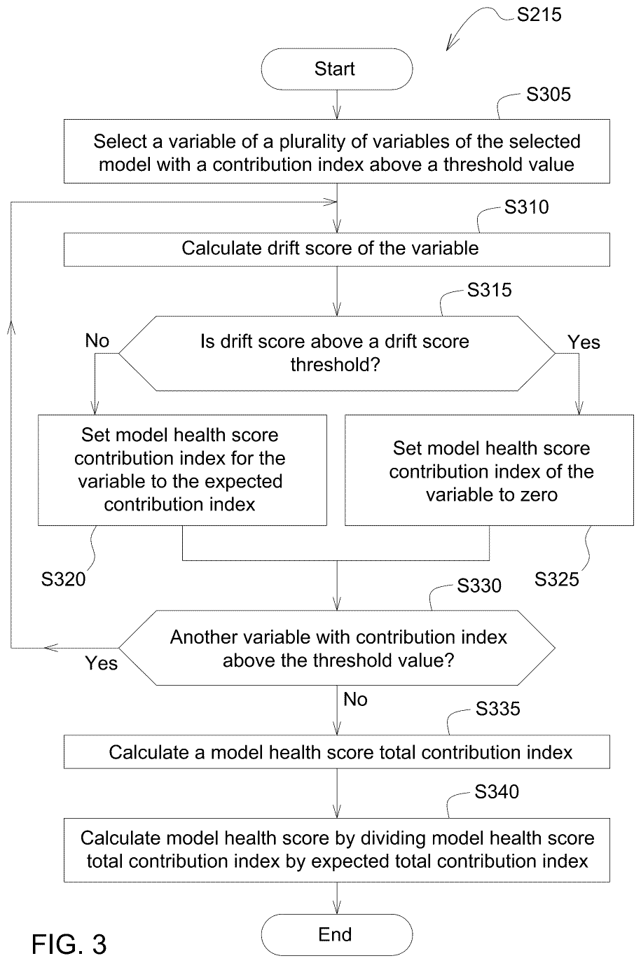

After a prediction of the selected model is selected, at step S215 a model health score for the selected prediction of the selected model may be determined. The model health score may indicate a viability of the selected model for the selected prediction. Additional details of determining the model health score will be described with respect to FIG. 3.

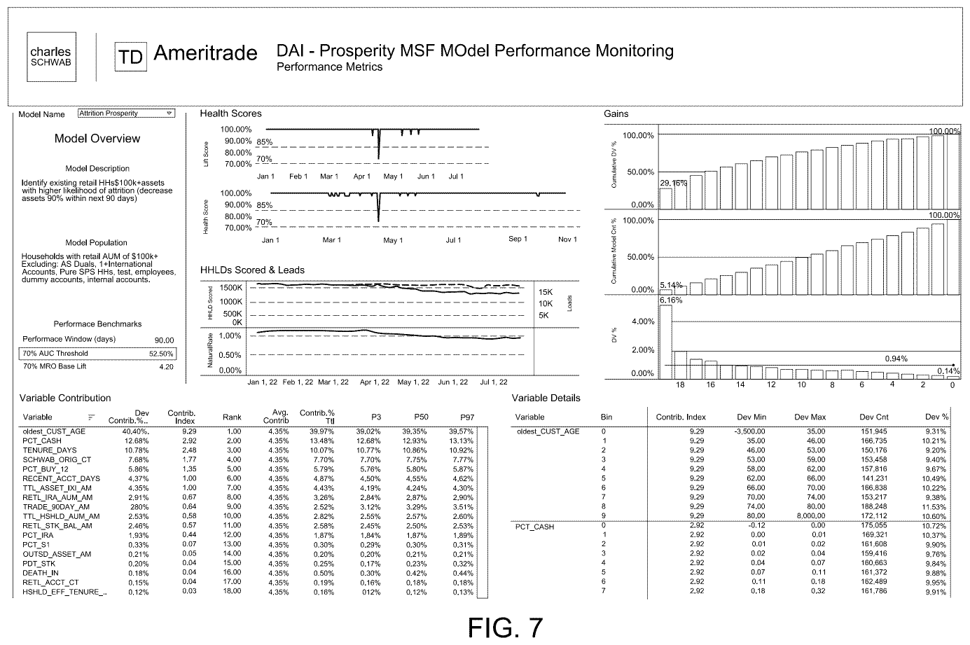

At step S220, a graphical user interface (GUI) may be generated. The GUI may include the determined model health score and additional details associated with the prediction of the model being analyzed by the model health score. For example, the GUI may include at least one of the model health score, a model health score over a period of time or a number of predictions, or performance information of the plurality of variables of the selected model. Example embodiments of a GUI that may be generated are discussed herein with respect to FIGS. 7-11.

FIG. 3 is a flow chart of the step S215 of FIG. 2. For example purposes, the example embodiment shown in FIG. 3 will be discussed with regard to the system shown in FIG. 1. However, example embodiments should not be limited to this example.

At step S305, a variable of the plurality of variables of the selected model may be selected. In at least one example embodiment, the processing circuitry 110 may select the variable. The selected variable may be a variable with a contribution index that is above a threshold value. In at least one example embodiment, each variable may have an expected contribution percentage for the selected model. Based on the expected contribution percentage, an expected contribution index for each variable may be determined.

The expected contribution index for each variable may be determined by a series of calculations. A contribution percentage of each variable may be defined by the model and may be a known value used to determine the contribution index. First, a total number of variables of the selected model may be determined. Then, an average contribution may be determined by a sum of each variable's contribution percentage divided by a total number of variables. The average contribution may be an average contribution of the selected model.

Once the average contribution is determined, the expected contribution index for a variable is determined by dividing the contribution percentage for that variable by the average contribution. For example, if a variable has a contribution percentage of 30% and the average contribution is 10%, the expected contribution index for that variable is 3.0. This calculation may be performed for each variable to determine the expected contribution index for each variable. In other embodiments, the expected contribution index may be determined by a different series of calculations but may be related to the contribution percentages of the variables of the selected model.

Referring back to step S305, a variable may be selected if it has an expected contribution index greater than a threshold value. In at least one example embodiment, the threshold value may be a value that is selected to exclude variables with a low impact on the model. For example, the threshold value may be 1.0 is some embodiments to exclude variables with an expected contribution index less than 1.0. This may allow variables to be selected and analyzed that have the greatest impact on the model health score.

After a variable is selected at the step S305, a drift score of the selected variable may be calculated at step S310 by the processing circuitry 110. In some embodiments, the drift score may be a population stability index (PSI) and in other embodiments, the drift score may be a different measure of drift of the selected variable such as an isolation forest model score, inter-quartile range, metric anomalies, general unsupervised data monitoring, an unsupervised learning clustering approach, Jensen-Shannon divergence drift, or another drift methodology.

The drift score may be determined by a series of calculations based on the contribution index. After the contribution index is determined for each variable, the contribution indexes that are above the threshold value may be added together to obtain a total contribution index. Then, the contribution index of each variable may be divided by the total contribution index to obtain an actual contribution percentage for each variable. A drift score may be calculated from the actual contribution percentage and the expected contribution percentage for each variable. For example, the drift score may be determined by subtracting the expected contribution percentage from the actual contribution percentage and then multiplying the result by the natural logarithm of the quotient of the actual contribution percentage divided by the expected contribution percentage. In at least one example embodiment, the drift score may provide a measure of drift from the expected contribution percentage for each variable of the selected model.

In at least one example embodiment, data for a model may be divided into one or more segments. The drift score for each variable may be determined within the specific segment in some embodiments. The steps of the method S215 may be performed for the data of each segment of the model data in at least one example embodiment.

Once the drift score is determined, at conditional step S315, the processing circuitry 110 may determine if the drift score of the selected variable is above a drift score threshold. The drift score threshold may be selected such that variables with a low drift score are ignored or excluded from future calculations because the actual contribution percentage of that variable is close to the expected contribution percentage.

If the drift score is above the drift score threshold, then a predictor contribution alert is flagged and a model health score contribution index for that variable is set to zero at step S325. If the drift score is not above the drift score threshold, then the predictor contribution alert is not flagged and the model health score contribution index for that variable is set to the expected contribution index at step S320.

At conditional step S330, the processing circuitry 110 determines whether there is another variable of the model that has a contribution index above the threshold value. If there is another variable with a contribution index above the threshold value, the method S215 returns to the step S310 for the next variable. If there is not another variable with a contribution index above the threshold value, the method S215 proceeds to step S335 where a model health score total contribution index is calculated. The model health score total contribution index is calculated by adding the model health score contribution index of each variable.

After the model health score total contribution index is calculated, the model health score is calculated at step S340. The processing circuitry 110 may calculate the model health score by dividing the model health score total contribution index by the total contribution index.

In at least one example embodiment, the model health score can be an indication of whether expected performance of a model has started to decay. The model health score may be a top level indicator of viability of the selected model. The model health score may provide a high level indication that may allow a user or an analyst to drill down into the prediction of the selected model to determine driving factors of the model health score.

In at least one example embodiment, an aggregate model health score may be determined. An aggregate model health score may be a score for a model over a particular period of days or over a particular number of predictions. For example, an aggregate model health score could indicate a model health score of a model over a period of seven days or for ten predictions of the model. In at least one example embodiment, an aggregate model health score may be determined based on a model health score of a selected prediction and a model health score and a lift health score of the selected model on one or more predictions within a range of the selected prediction.

The lift health score of the selected model may be determined based on an actual performance of selected mature predictions. The lift health score translates traditional performance metrics to a 100 point scale with threshold values to determine alerting criteria.

In at least one example embodiment, an alert may be output if the expected performance of the model has started to decay. For example, a first alert may be output if the model health score has dropped below a first threshold and a second alert may be output if the model health score has dropped below a second threshold. The second threshold may be less than the first threshold. For example, the first threshold may be 85% and the second threshold may be 70%. If the model health score is less than 85% but greater than or equal to 70%, a first alert may be output. If the model health score is less than 70%, a second alert may be output. In other example embodiments, the first threshold and the second threshold may be adjusted based on desired decay thresholds for a particular model.

In at least one example embodiment, the variables of the plurality of variables of a particular model may have a variable health for each prediction of the particular model.

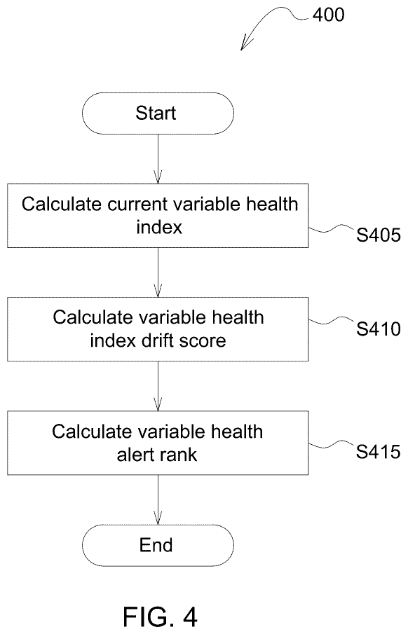

FIG. 4 is a flow chart of a method 400 of determining a variable health alert rank. For example purposes, the example embodiment shown in FIG. 4 will be discussed with regard to the system shown in FIG. 1. However, example embodiments should not be limited to this example.

The method 400 may start at step S405 where the processing circuitry 110 calculates a variable health index. The variable health index may be a contribution index for the variable for a given prediction. The variable health index may be calculated for each variable for a prediction of the selected model. The variable health index may be calculated by dividing the actual contribution percentage of the variable by an average of the actual contribution percentage of each of the variables of the model.

After the variable health index is calculated, at step S410 the processing circuitry 110 may calculate a variable health index drift score. In at least one example embodiment, the variable health index drift score may be determined by subtracting the total contribution index from the variable health index and then multiplying the result by the natural logarithm of the quotient of the variable health index divided by the total contribution index. The variable health index drift score may be a measure of drift of the variable from the expected contribution of the variable for the particular prediction. As described above with reference to FIG. 3, the total contribution index is a sum of the contribution indexes that are above the threshold value for a given prediction.

After the variable health index drift score is calculated, at step S415 the processing circuitry 110 may calculate a variable health alert rank. The variable health alert rank may be determined from the variable health index drift score of each of the variables of the selected model. In at least one example embodiment, the variable health alert rank for each of the variables may be calculated by subtracting the quotient of the variable health index divided by the maximum variable health index of each of the variables of the selected prediction from one. The variable health alert rank may indicate a viability of the variable for the selected prediction for the selected model. If a variable has a high variable health alert rank, the variable may have performed as expected and may have an actual contribution that is close to the expected contribution for that variable. If a variable has a lower variable health alert rank, the variable may not have performed as expected for the selected prediction of the selected model and may have a variable health index that is not close to the expected contribution index.

In at least one example embodiment, a variable health score may also be calculated for each variable of a prediction. The variable health score may indicate performance of a variable for a prediction of the selected model. In at least one example embodiment, the variable health score may be calculated by subtracting the quotient of the actual contribution percentage of the variable divided by the expected contribution percentage of the variable from a factor that is determined by the quotient value in order to scale the variable health score from 0 to 100.

The variable health score may differ from the variable health alert rank because it may be possible for two or more variables to have the same variable health score but it is not possible for two or more variables to have the same variable health alert rank. However, the variable health score may similarly indicate a viability of the variable for the selected prediction for the selected model. If a variable has a high variable health score, the variable may have performed as expected and may have an actual contribution that is close to the expected contribution for that variable. If a variable has a lower variable health score, the variable may not have performed as expected for the selected prediction of the selected model and may have a variable health index that is not close to the expected contribution index.

In at least one example embodiment, the variable health score and/or the variable health alert rank may be used to determine a root cause of the model health score for a prediction of the selected model. For example, the variable health scores may be ranked and the variable health score that is furthest from 100% may be the largest contributing factor to the model health score. Similarly, the variable health alert rank that is the furthest from 100% may be the largest contributing factor to the model health score. This determination may allow a user or analyst to review specific portions of the model to determine if any updates need to be made to increase the viability of the selected model or to determine if the model needs to be paused so that no further predictions occur until further analysis of the model.

In at least one example embodiment, an alert may be output if the expected performance of the model has started to decay as described above. There may be specific alerts for each variable that may be output based on the calculated variable health scores and/or variable health alert ranks for a prediction of a selected model. For example, a first alert may be output if the variable health score has dropped below a first threshold and a second alert may be output if the variable health score has dropped below a second threshold. The second threshold may be less than the first threshold. For example, the first threshold may be 85% and the second threshold may be 70%. If the variable health score is less than 85% but greater than or equal to 70%, a first alert may be output. In at least one example embodiment, the first alert may appear as a warning on a GUI analyzing the selected model. If the variable health score is less than 70%, a second alert may be output. In at least one example embodiment, the second alert may appear as an error on a GUI analyzing the selected model. In other example embodiments, the first threshold and the second threshold may be adjusted based on desired decay thresholds for a particular model and/or variable.

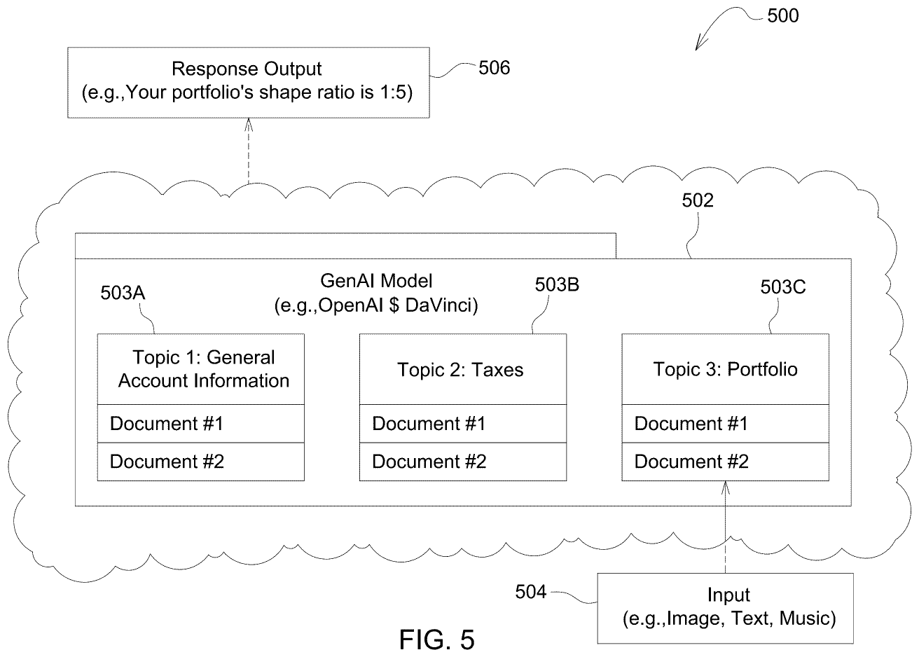

FIG. 5 is a diagram of a generative artificial intelligence (“AI”) system 500 that may include one or more models that may be scored via the model health score described above. In particular, the model health score may be used to determine a viability of one or more of the models of the generative AI system 500 based on a prediction of the one or more models. In at least one example embodiment, the generative AI system 500 may be implemented by the device 100 described above with reference to FIG. 1. For example, the generative AI system 500 may be implemented by the processing circuitry 110, may store a plurality of models in the memory 130, and may receive input and output information via the at least one I/O device 150.

The generative AI system 500 is a type of artificial intelligence designed to create new content, such as text, image, music, or other data, that mimics human creativity. The processing circuitry 110 of the generative AI system 500 may be configured to receive an input prompt, encode the input prompt, recall relevant documents and process models, and decode and generate an output.

The input prompt may be received from a user and may be text, an image, or another form of input. The input prompt may generically describe a desired output. For example, “Who is this person in this picture?” or “Generate an image of a futuristic city at sunset.” or “Modify this picture that I've uploaded to add a beach.”

The input prompt may be encoded by converting the input prompt into a numerical format that the generative AI system 500 can process. For text prompts, converting the input prompt may involve tokenization to breakdown text into smaller units which are then embedded to capture a meaning of the input prompt.

Recalling relevant documents and model processing involves feeding the encoded prompt into a plurality of generative AI models of the generative AI system 500. The encoded prompt may be fed into the plurality of generative AI models with relevant documents associated with a theme, topic, or intent of the encoded prompt. The generative AI model 500 is configured to explore latent space or high dimensional space where different aspects of the prompt are represented. Model processing may generate processed information to be used in decoding and output generation steps.

Decoding and generation of an output uses the processed information to generate an output. For example, generating an output may involve constructing sentences and/or paragraphs that align with the input prompt, generating pixel values or patterns that form an image corresponding to the input prompt, or generating another type of output corresponding to the input prompt.

In at least one example embodiment, a plurality of models may be associated with the generative AI system 500. In particular, the generative AI system 500 may include a topic assignment model 502 and a plurality of topics 503A, 503B, 503C. Each topic of the plurality of topics 503A, 503B, 503C may be associated with a model. The generative AI system 500 may receive input 504 from a user or from another system such as the input prompt described above. The input 504 may be a text input, such as a phrase or a question, an article, an image, music, or another input that may be converted into a machine decipherable format. For text data inputs, an intermediary topic assignment model may be configured and leveraged.

The topic assignment model 502 may be configured to receive the input 504 and analyze the input against each of the models associated with the plurality of topics 503A, 503B, 503C to determine a topic and relevant documents that correspond to the input 504. Once a topic is assigned to the input and relevant documents are identified by the topic assignment model 502, the model processing and generation with the associated documents may determine an output 506.

In at least one example embodiment, the model health score as described in FIGS. 2-4 may be applied to the generative AI system 500 wherever and whenever an expected benchmark best response can and has been defined. In at least one example embodiment, an expected benchmark best response may be identified at the input and document retrieval step, and again at the output step. However, embodiments are not limited herein.

For example, a prediction may be a series of events beginning with the generative AI system 500 receiving the input 504 and choosing a topic with the topic assignment model 502. The prediction may also be the output 506 of the model of a selected topic in response to the input 504. In particular, the model health score may be used to track a topic's viability based on a topic's variables versus actual input text. The model health score may also be used to compare the output 506 of the generative AI system to a recorded best response. Thus, the generative AI system can be monitored based on the model health score to determine when viability of either the topic assignment model 502 or any of the models associated with the plurality of topics 503A, 503B, 503C is decreasing so that the models may be adjusted and/or updated to ensure they remain functioning as intended.

In at least one example embodiment, the input 504 may be a text string that is a question that is input into the generative AI system 500. For example, the input 504 may be: “What's my portfolio's risk?” The topic assignment model 502 may determine a topic associated with the input 504 such as a “Portfolio” topic 503C of the plurality of topics 503A, 503B, 503C. Then, a model associated with the “Portfolio” topic may determine the output 506 of “Your portfolio's Sharpe ratio is 1.5.”

In at least one example embodiment, each model of a plurality of a models associated with the plurality of topics includes a plurality of variables. For example, a first model may be associated with an “Arts & Culture” topic. The model associated with the “Arts & Culture” topic may include a plurality of variables such as keywords that are associated with the topic. For example, the model associated with the “Arts & Culture” topic may include variables such as “artist,” “art,” “book,” “sculpture,” “Broadway,” etc. A second model may be associated with an “Environment” topic. The model associated with the “Environment” topic may include a plurality of variables such as “climate,” “animal,” “oil,” “change,” “spill,” “gas,” etc. The topic assignment model may use keywords from each of the models to determine an output topic in response to the input in at least one example embodiment.

Once a topic is assigned to the input 504 by the topic assignment model 502, the model associated with the topic may determine the output 506. For example, if the “Arts & Culture” topic is selected by the topic assignment model 502, the model associated with the “Arts & Culture” topic may generate an output 506 responsive to the input 504 that was input to the generative AI system 500. Alternatively or additionally, the output 506 may be the topic that is assigned by the topic assignment model.

As an example, an Arts & Culture topic may have an associated model that includes a plurality of variables. The variables may be organized based on variable weight. For example, the top ten variables with their associated variable weight for the Arts & Culture topic may be: variable 1, 50.1%; variable 2, 49.1%; variable 3, 44.0%; variable 4, 37.0%; variable 5, 34.3%; variable 6, 33.4%; variable 7, 33.2%; variable 8, 33.0%; variable 9, 32.1%; variable 10 32.1%. In at least one example embodiment, the variable weights may be normalized to determine the expected contribution percentage for each variable. For example, based on the variable weights above, each variable weight may be divided by a sum of the total variable weights (378.4%) to determine the expected contribution percentage for each variable. Thus, the expected contribution percentage of each variable is: variable 1, 13.2%; variable 2, 13.0%; variable 3, 11.6%; variable 4, 9.8%; variable 5, 9.1%; variable 6, 8.8%; variable 7, 8.8%; variable 8, 8.7%; variable 9, 8.5%; variable 10, 8.5%. The variables for the Arts & Culture topic may be words associated with arts and culture such as “art”, “artist”, “sculpture”, “book”, etc.

The calculations for the model health score then follow the calculations described above with reference to FIGS. 2-4. The calculations described for the Arts & Culture topic are described with reference to the device 100 of FIG. 1. The calculations may be performed by a different entity or system and are not limited to the embodiment described herein. For example, the processing circuitry 110 may then determine the expected contribution index for each variable. In this example embodiment, the expected contribution index for each variable is: variable 1, 1.32; variable 2, 1.30; variable 3, 1.16; variable 4, 0.98; variable 5, 0.91; variable 6, 0.88; variable 7, 0.88; variable 8, 0.87; variable 9, 0.85; variable 10, 0.85.

As described above, a variable may be selected for determination of the model health score if it has an expected contribution index that is greater than a threshold value. For example, if the threshold value is 0.90, then the variables that are used to determine the model health score for the Arts & Culture topic are: variable 1, variable 2, variable 3, variable 4, and variable 5. The expected total contribution index is then determined as the sum of the expected contribution indexes that are above the threshold. Thus, the variables above the threshold value are expected to have the greatest impact on the model health score of the variables of the selected model.

For a selected prediction of the model associated with the Arts & Culture topic, the variables may have the following variable weights: variable 1, 51.1%; variable 2, 11.4%; variable 3, 42.5%; variable 4, 35.5%; variable 5, 35.1%; variable 6, 33.3%; variable 7, 33.3%; variable 8, 32.1%; variable 9, 31.7%; variable 10, 31.7%. Thus, the normalized weights are: variable 1, 13.6%; variable 2, 3.0%; variable 3, 11.3%; variable 4, 9.4%; variable 5, 9.3%; variable 6, 8.8%; variable 7, 8.8%; variable 8, 8.5%; variable 9, 8.4%; variable 10, 8.4%. The normalized weights are the actual contribution percentages for the variables.

The drift score for each variable may be calculated from the actual contribution percentage and the expected contribution percentage for each variable as described above. In this example embodiment, variable 2 has a drift score that is above a drift score threshold while the remainder of the variables have drift scores less than the drift score threshold. As described above, when the drift score is above the drift score threshold, a predictor contribution alert is flagged and a model health score contribution index for that variable is set to zero. Thus, the model health score contribution index for variable 2 is set to zero. If the drift score is not above the drift score threshold, then the predictor contribution alert is not flagged and the model health score contribution index is set to the expected contribution index. Thus, the model health score contribution index for the remaining variables is set to the expected contribution index for the respective variable. The model health score total contribution index is then determined as a sum of the expected contribution indexes that have not been flagged. The model health score is then determined by dividing the model health score total contribution index by the expected total contribution index. Here, the model health score total contribution index is 4.37 and the expected total contribution index is 5.67 and thus the model health score is 77%. Thus, performance of the model associated with the Arts & Culture topic is not as expected and an alert would be output for this prediction.

A variable health alert rank for each variable of the model associated with the Arts & Culture topic may be calculated as described above in FIG. 4. For example, for the variables of the Arts & Culture topic, a variable health index is calculated by dividing the actual contribution percentage of the variable by an average of the actual contribution percentage of each of the variables of the model. Thus, the variable health index for variable 1 is 13.6% divided by 9.0% which equals 1.51 and the variable health index for variable 2 is 3.0% divided by 9.0% which equals 0.34. Then, the variable health index drift score is calculated by subtracting the expected contribution index from the variable health index and then multiplying the result by the natural logarithm of the quotient of the variable health index divided by the total contribution index. Here, the variable health index drift score for variable 1 is approximately 0.03 and the variable health index drift score for variable 2 is approximately 1.30.

The variable health index drift of each variable may be used to determine the variable health alert rank for each variable. In particular, the variable health alert rank may be determined by subtracting the quotient of the variable health index divided by the maximum variable health index of all of the variables of the selected prediction from one. Here, the variable health alert rank for variable 1 may be 98% while the variable health alert rank of variable 2 may be 0%. The variable health alert rank may indicate a difference between the variable health index and the expected contribution index.

The variable health score may then be calculated for each variable by subtracting the quotient of the actual contribution percentage of the variable divided by the expected contribution percentage of the variable from a factor that is determined by the quotient value in order to scale the variable health score from 0 to 100. Here, the variable health score for variable 1 may be 92% and the variable health score for variable 2 may be 25%. As described above, the variable health score and/or the variable health alert rank may be used to determine a root cause of the model health score for a prediction of the selected model. In the example prediction of the model of the Arts & Culture topic described herein, variable 2 has the lowest variable health score and variable health alert rank. Thus, variable 2 may have a large impact on the model health score for this prediction.

The model health score may be used on a plurality of different models to determine viability of a model. The model health score calculations described above with respect to FIGS. 2-4 may be adapted to additional models that include a plurality of variables.

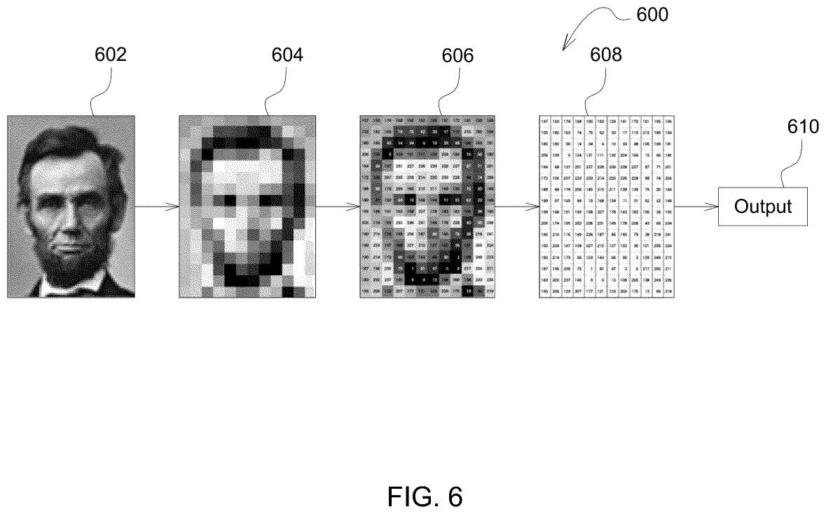

FIG. 6 is a flow chart of a generative AI system 600. The generative AI system 600 may include an image recognition model. The image recognition system may be a generative AI system that may be similar or analogous to the generative AI system 500 described in FIG. 5. For example purposes, the example embodiment shown in FIG. 6 will be discussed with regard to the systems shown in FIGS. 1 and 5. In at least one example embodiment, an input 602 may be an image of Abe Lincoln that is input into the generative AI system 600 with regard to the system shown in FIG. 1. In at least one example embodiment, the process circuitry 110 may then extract the color layers of the image and pixelate the image which results in a pixelated image at step 604. Then, the processing circuitry 110 may vectorize and assign a number or a weight to each pixel of the pixelated image in step 606. For example, each pixel of the image may be assigned a number from 0 to 1 that represents a depth of its greyscale. In step 608, the processing circuitry 110 may view the pixelated image that is weighted as only a series of numbers or weights and thus, there may be no color associated with the image. From the numbers and/or weights, the processing circuitry 110 outputs a description of the image at step 610.

The processing circuitry 110 may similarly pixelate, vectorize, and assign a number or a weight to each of the extracted color images. For example, red/green/blue (RGB) may be extracted and may each be pixelated and assigned a number similar to the greyscale image as shown in FIG. 6. In other embodiments, other color systems may be used such as cyan/magenta/yellow. The image recognition system may perform the method 600 for each color and may then combine the results to determine the final output in at least one example embodiment.

In at least one example embodiment, the generative AI system 600 may receive an image as an input 602 from a user or from another system to be analyzed by the generative AI system 600. In particular, the generative AI system may include an image assignment model that may be configured to receive the input 602 and analyze the input against each of the models associated with the plurality of images to determine a description that corresponds to the input 602. For example, if an image of a black and white Abe Lincoln is input, the image recognition system should output that the image is Abe Lincoln. However, if a model of the image recognition system is not functioning properly, the image recognition system may instead output that the image is a cow or a dog, for example.

In at least one example embodiment, the generative AI system 600 may be a plurality of models associated with a plurality of descriptions including a plurality of variables. The plurality of variables may be individual pixels of an image that are vectorized into numbers and/or weighted pixelated color layers. For example, a first model may be associated with an “Abe Lincoln” description. The model associated with the “Abe Lincoln” description may include a plurality of variables in permutations that are associated with the description. For example, the model associated with the “Abe Lincoln” description may include variables associated with eyes, ears, nose, shape, etc. A second model may be associated with a “Car” description. The model associated with the “Car” description may include a plurality of variables associated with wheels, steering wheels, headlights, car shapes, etc. The image recognition system may use variables from each of the models to determine an output description in response to the input in at least one example embodiment. Thus, for a given prediction, a model may be analyzed and assigned a model health score based on an output of the model as compared to an expected output of the model from the values of each pixel as the variables of the model.

As described above, a model that has a plurality of variables and an expected output that can be compared to an actual output and may be analyzed with the model health score system to determine a viability of the model. In at least one example embodiment, a prediction of a model of the generative AI system 600 used to determine a model health score may be a previously executed result of the generative AI system 600. For example, a prediction may be a series of events beginning with the generative AI system 600 receiving the input and choosing a category with the image recognition model. The prediction may also be the output of the model of a selected image recognition model in response to the input. In particular, the model health score may be used to track an image's description viability based on an image's variables versus actual input image. The model health score may also be used to compare the output of the generative AI system to a recorded best response. Thus, the generative AI system can be monitored based on the model health score to determine when viability of either the image recognition model or any of the models associated with the plurality of images is decreasing so that the models may be adjusted and/or updated to ensure they remain functioning as intended.

As an example, an Abe Lincoln image may have an associated model that includes a plurality of variables. The variables may be organized based on variable weight and respective distances. For example, the top ten variables with their associated variable weight for the Abe Lincoln image may be the relative distances and weights of pixels that comprise the eyes, nose, ears, etc.: pixel 1, 0.97%; pixel 2, 0.85%; pixel 3, 0.40%, pixel 4, 0.78%; pixel 5, 0.62%; pixel 6, 0.26%; pixel 7, 0.85%; pixel 8, 0.20%; pixel 9, 0.97%; pixel 10, 0.93%. In at least one example embodiment, the variable weights may be normalized to determine the expected contribution percentage for each variable. For example, based on the variable weights above, each variable weight may be divided by a sum of the total variable weights (6.8%) to determine the expected contribution percentage for each variable. Thus, the expected contribution percentage of each variable is: pixel 1, 14.2%; pixel 2, 12.4%; pixel 3, 5.8%, pixel 4, 11.4%; pixel 5, 9.1%; pixel 6, 3.8%; pixel 7, 12.5%; pixel 8, 3.0%; pixel 9, 14.2%; pixel 10, 13.7%.

The calculations for the model health score then follow the calculations described above with reference to FIGS. 2-4. The calculations described for the Abe Lincoln description are described with reference to the device 100 of FIG. 1. The calculations may be performed by a different entity or system and are not limited to the embodiment described herein. For example, the processing circuitry 110 may then determine the expected contribution index for each variable. In this example embodiment, the expected contribution index for each variable in the slice as previously described is: pixel 1, 1.42; pixel 2, 1.24; pixel 3, 0.58, pixel 4, 1.14; pixel 5, 0.91; pixel 6, 0.38; pixel 7, 1.25; pixel 8, 0.30; pixel 9, 1.42; pixel 10, 1.37.

As described above, a variable may be selected for determination of the model health score if it has an expected contribution index that is greater than a threshold value. For example, if the threshold value is 0.90, then the variables that are used to determine the model health score for the Abe Lincoln description are: pixel 1, pixel 2, pixel 4, pixel 5, pixel 7, pixel 9, and pixel 10. The expected total contribution index is then determined as the sum of the expected contribution indexes that are above the threshold. Thus, the variables above the threshold value are expected to have the greatest impact on the model health score of the variables of the selected model.

For a selected prediction of the model associated with the Abe Lincoln description, the variables may have the following variable weights: pixel 1, 1.0%; pixel 2, 0.0%; pixel 3, 0.4%, pixel 4, 0.8%; pixel 5, 1.2%; pixel 6, 0.3%; pixel 7, 1.7%; pixel 8, 0.4%; pixel 9, 0.0%; pixel 10, 0.9%. Thus, the normalized weights are: pixel 1, 14.4%; pixel 2, 0.0%; pixel 3, 5.9%, pixel 4, 11.6%; pixel 5, 18.6%; pixel 6, 3.8%; pixel 7, 25.5%; pixel 8, 6.1%; pixel 9, 0.0%; pixel 10, 14.0%. The normalized weights are the actual contribution percentages for the variables.

The drift score for each variable may be calculated from the actual contribution percentage and the expected contribution percentage for each variable as described above. The drift score for variable 2, variable 5, variable 7, and variable 9 are each above the drift score threshold while the remainder of the variables have drift scores less than the drift score threshold. As described above, when the drift score is above the drift score threshold, a predictor contribution alert is flagged and a model health score contribution index for that variable is set to zero. Thus, the model health score contribution index for variables 2, 5, 7, and 9 is set to zero. If the drift score is not above the drift score threshold, then the predictor contribution alert is not flagged and the model health score contribution index is set to the expected contribution index. Thus, the model health score contribution index for the remaining variables is set to the expected contribution index for the respective variable. The model health score total contribution index is then determined as a sum of the expected contribution indexes that have not been flagged. The model health score is then determined by dividing the model health score total contribution index by the expected total contribution index. Here, the model health score total contribution index is 3.92 and the expected total contribution index is 8.74 and thus the model health score is 45%. Thus, performance of the model associated with the Abe Lincoln description is not within an expected range and an alert would be output for this prediction.

A variable health alert rank for each variable of the model associated with the Abe Lincoln description may be calculated as described above in FIG. 4. For example, for the pixel 2 variable, a variable health index is calculated by dividing the actual contribution percentage of the variable by an average of the actual contribution percentage of each of the variables of the model. Thus, the variable health index for the pixel 2 variable is 0.00% divided by 10.0% which equals 0.00. Then, the variable health index drift score is calculated by subtracting the actual contribution index from the variable health index and then multiplying the result by the natural logarithm of the quotient of the variable health index divided by the actual contribution index. Here, the variable health index drift score for the pixel 2 variable is approximately 8.33.

The variable health index drift of the pixel 2 variable may be used along with the variable health index drift score of each of the other variables of the model associated with the Abe Lincoln description to determine the variable health alert rank for the pixel 2 variable. The variable health alert rank may be determined by subtracting the quotient of the variable health index divided by the maximum variable health index of all of the variables of the selected prediction from one. Here, the variable health alert rank for the pixel 2 variable may be 0%. The variable health alert rank may indicate a difference between the variable health index and the expected contribution index.

The variable health score may also be calculated for the pixel 2 variable. As described above, the variable health score may be calculated by subtracting the quotient of the actual contribution percentage of the variable divided by the expected contribution percentage of the variable from a factor that is determined by the quotient value in order to scale the variable health score from 0 to 100. Here, the variable health score for the pixel 2 variable may be 0%. As described above, the variable health score and/or the variable health alert rank may be used to determine a root cause of the model health score for a prediction of the selected model. In the example prediction of the model of the Abe Lincoln description, the pixel 2 variable has the lowest variable health score and variable health alert rank. Thus, the pixel 2 variable may have a large impact on the model health score for this prediction.

The model health score may be used on a plurality of different models to determine viability of a model. The model health score calculations described above with respect to FIGS. 2-4 may be adapted to additional models that include a plurality of variables.

In at least one example embodiment, the generative AI system 500 and/or the generative AI system 600 may be configured to work in reverse. For example, if an input is a request for an output image of Abe Lincoln, then the generative AI system 500 and/or the generative AI system 600 may identify a correct model that may be used to generate an image of Abe Lincoln. Further, the generative AI system 500 and/or the generative AI system 600 may be able to combine text and image prompts to output an image of Abe Lincoln in a blue hat if the input is a request for an image of Abe Lincoln in a blue hat.

FIG. 7 is an example GUI that shows a model overview for a model. The GUI includes a graph of a lift score for the model over a period from January 1 to July 1. The GUI may additionally include a graph of a model health score for the model from January 1 to November 1. The model health score and the lift score show similar trends and particular days or predictions on certain days that show a decline in viability of the model. The GUI additionally includes a section related to variable contribution and variable details which may be drilled into to determine which variables were the most impactful for a particular prediction of the model. The variable details may be shown broken down into particular bins or segments. The data for the prediction of the model may be analyzed by bin or segment as described above.

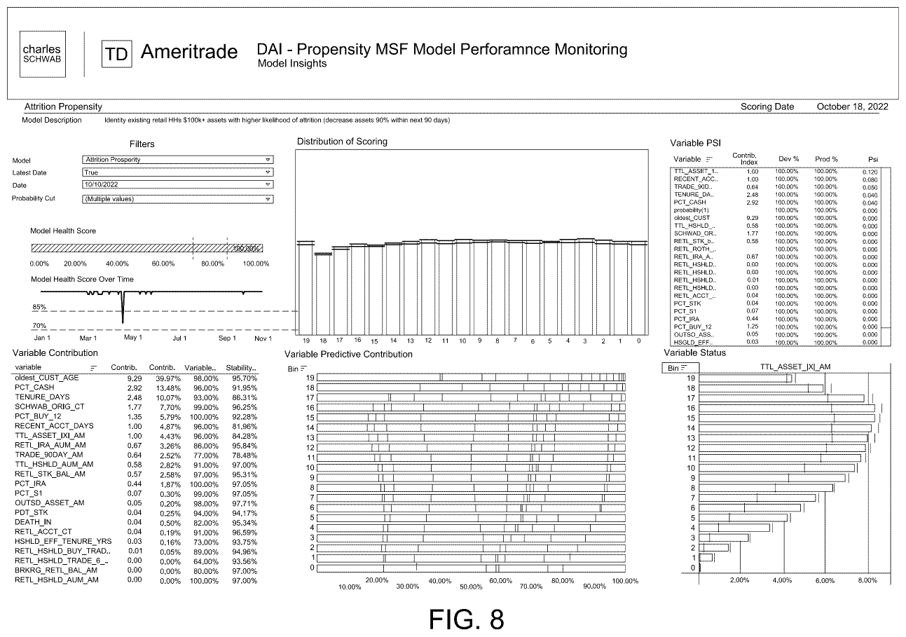

FIG. 8 shows an example GUI of a model overview for a particular model on a selected date. Although showing a selected date, a model overview may also be shown for a particular prediction of a selected model. In at least one example embodiment, instead of a selected date, details of a selected prediction may be shown on the GUI. The model on the selected date of Oct. 18, 2022 shows a model health score of 100% indicating that the model generally performed as expected. The GUI shows the variables of the selected model and details of each variable's contribution to the model health score.

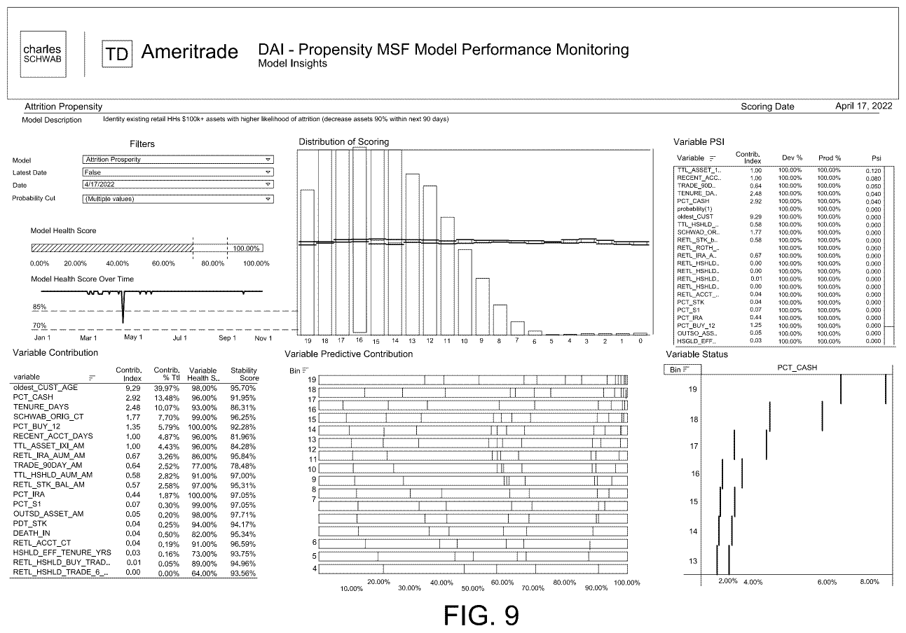

FIG. 9 shows an example GUI of a model overview for the particular model of FIG. 8 on a second date where the model health score is less than 100%. The model on Apr. 17, 2022 produced a model health score of 75.84%. The variables of the model on this date performed differently than on the model prediction of Oct. 18, 2022, and can be analyzed to determine a driving factor for the model health score.

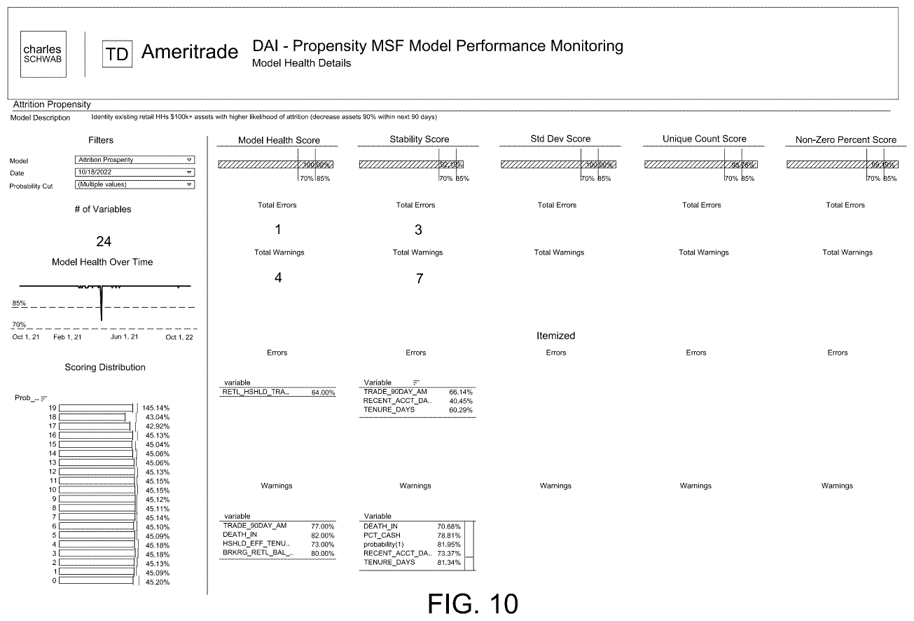

FIG. 10 shows an example GUI of a variable analysis screen for the model of FIG. 8. The GUI indicates that there are 24 variables for the selected model and shows an itemized list of variables that are impacting the model health score as well as other metrics of the model for the selected prediction. The model may include one variable that has a variable health score that is less than a second threshold which may show that the variable is producing an error for the model health score. The model additionally includes four variables that have a variable health score that is between the first threshold and the second threshold and thus are shown as variables that produce a warning for the model health score.

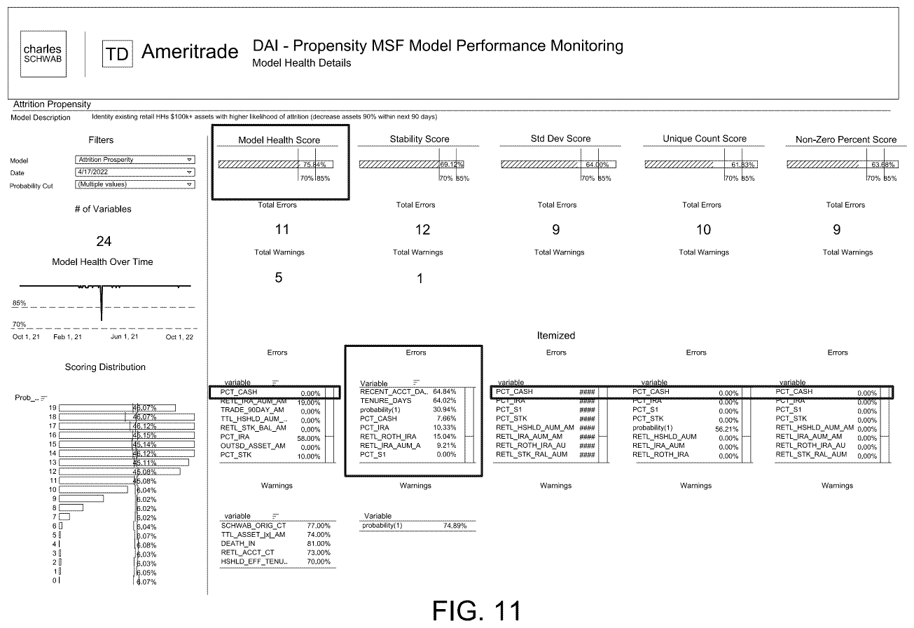

FIG. 11 shows an example GUI of a variable analysis screen for the model of FIG. 9. The GUI indicates that there are 24 variables for the selected model and shows an itemized list of variables that are impacting the model health score as well as other metrics of the model for the selected prediction. The model may include eleven variables that have a variable health score that is less than a second threshold which may show that these variables are producing an error for the model health score. The model additionally includes five variables that have a variable health score that is between the first threshold and the second threshold and thus are shown as variables that produce a warning for the model health score.

FIGS. 10 and 11 additionally illustrate auxiliary scores for a prediction of the selected model. The auxiliary scores may provide an indication of an underlying cause for a variable's performance for a given prediction. More generally, the systems and methods described herein provide three levels of analysis. A model health score provides a high level score of a prediction of a model. A variable health score and/or a variable health alert rank provides an indication of a root cause variable or variables which are most impactful to the model health score. Then, the auxiliary scores provide an indication of a diagnosis for the variable or variables identified by the variable health score and the variable health alert rank. A user may be able to quickly mitigate any problem with a prediction by identifying specific problems or anomalous behavior of one or more variables based on the auxiliary scores. The auxiliary scores include a stability score, a standard deviation score, a unique count score, and a non-zero percent score. Similar to the model health score, the GUI may identify variables that are causing either an error or a warning in one or more of the auxiliary scores.

The stability score may identify predictor distribution drift alerts. In at least one example embodiment, the stability score may be the variable health score. Additionally or alternatively, the stability score may identify a drift score of a variable which may be determined by a PSI, an isolation forest model score, inter-quartile range, metric anomalies, general unsupervised data monitoring, an unsupervised learning clustering approach, Jensen-Shannon divergence drift, or another drift methodology.

As shown in FIG. 10, the model may include three distinct variables that have a stability score that is less than a second threshold which may show that the variable is producing an error for the stability score. The model additionally includes seven distinct variables that have a stability score that is between a first threshold and the second threshold and thus are shown as variables that produce a warning for the stability score. As shown in FIG. 11, the model may include twelve distinct variables that have a stability score that is less than the second threshold which may show that the variable is producing an error for the stability score. The model additionally includes one distinct variable that has a stability score that is between the first threshold and the second threshold and thus are shown as variables that produce a warning for the stability score. The thresholds may be set prior to a prediction of the selected model and may be adjusted. In at least one example embodiment, the first threshold may be 85% and the second threshold may be 70%.

The standard deviation auxiliary score may indicate a dispersion of a variable. In particular, a non-zero standard deviation score may indicate that the variable is distributed. As shown in FIG. 10, the model may include no variables that have an error or a warning for the standard deviation score. As shown in FIG. 11, the model may include nine distinct variables that have a standard deviation score that is less than a second threshold which may show that the variable is producing an error for the standard deviation score. The model does not have any variables that are between a first threshold and the second threshold and thus does not have any variables producing a warning for the standard deviation score. The thresholds may be set prior to a prediction of the selected model and may be adjusted. In at least one example embodiment, the first threshold may be 85% and the second threshold may be 70%.

The unique count auxiliary score indicates how many values of a variable appear for selected predictions. A high unique count score indicates that the variable has variety. As shown in FIG. 10, the model may include no variables that have an error or a warning for the unique count score. As shown in FIG. 11, the model may include ten distinct variables that have a unique count score that is less than a second threshold which may show that the variable is producing an error for the unique count score. The model does not have any variables that are between a first threshold and the second threshold and thus does not have any variables producing a warning for the unique count score. The thresholds may be set prior to a prediction of the selected model and may be adjusted. In at least one example embodiment, the first threshold may be 85% and the second threshold may be 70%.

The non-zero percent auxiliary score may indicate what percentage of a variable's values are non-zero. A high non-zero percent score indicates that the variable is populated. If a variable is not populated correctly, then the variable's impact on the selected predictions may be different than expected. As shown in FIG. 10, the model may include no variables that have an error or a warning for the non-zero percent score. As shown in FIG. 11, the model may include nine distinct variables that have a non-zero percent score that is less than a second threshold which may show that the variable is producing an error for the non-zero percent score. The model does not have any variables that are between a first threshold and the second threshold and thus does not have any variables producing a warning for the non-zero percent score. The thresholds may be set prior to a prediction of the selected model and may be adjusted. In at least one example embodiment, the first threshold may be 85% and the second threshold may be 70%.

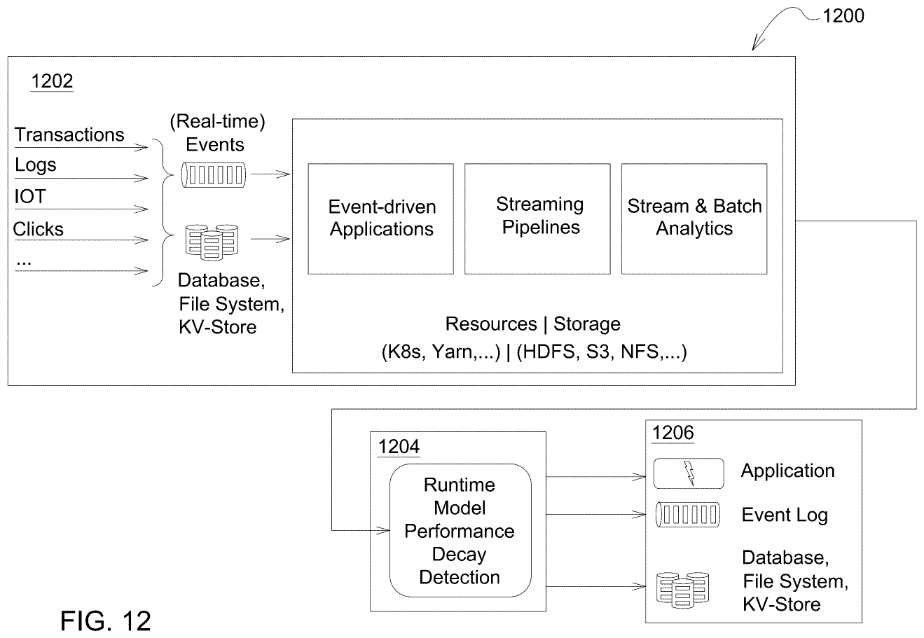

FIG. 12 is a block diagram of a prediction system 1200 that may be used with the example embodiments described herein. At box 1202, an action may trigger a process flow of the prediction system 1200. For example, the action may be a real time event such as a client logging into a particular system that may trigger downstream events to occur. Other actions that may trigger a process flow of the prediction system 1200 include collect model predictors such as a number of days since a last account opening and a number of total trades in the last 30 days.

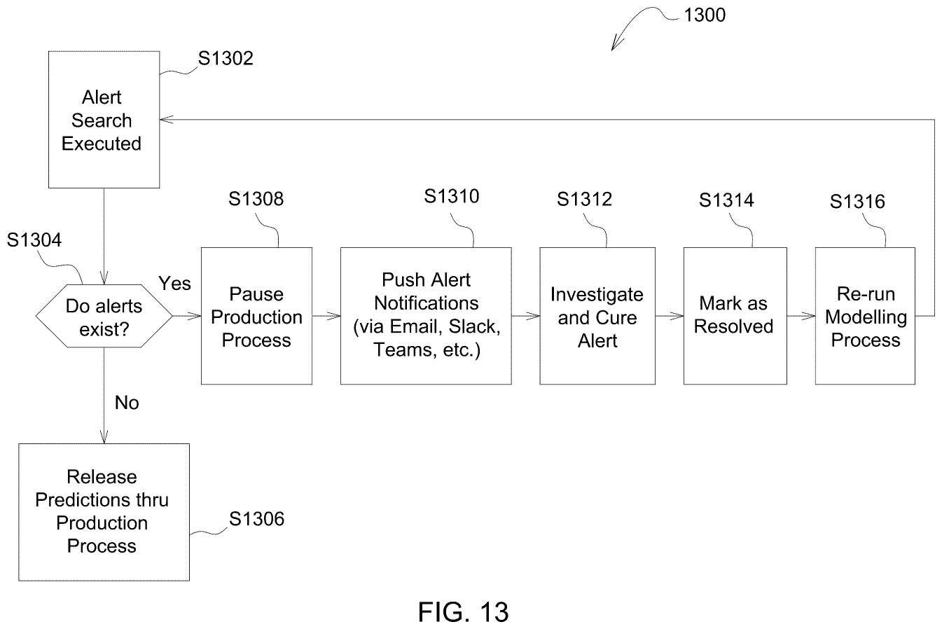

After an action triggers a process flow of the prediction system 1200, at box 1204 a runtime model performance decay detection process occurs. The runtime model performance decay detection process may be the method 200 of determining a model health score as described herein. The runtime model performance decay detection process may trigger an alert search process that will be described below with reference to FIG. 13.

After the runtime model performance decay detection process is complete, at box 1206 the prediction system 1200 will publish the determined predictions and scores from the box 1204. For example, a model health score determined by the method 200 may be published to an application event log and/or a database.

FIG. 13 is a block diagram of a method 1300 of a response operation based on an alert search being executed. The alert search may be executed for a particular model or for a selection of models and/or predictions to determine if an alert has been found and needs to be investigated. For example purposes, the example embodiment shown in FIG. 13 will be discussed with regard to the system shown in FIG. 1. However, example embodiments should not be limited to this example.

At S1302, an alert search is executed by the processing circuitry 110. In at least one example embodiment, the alert search may be executed by the runtime model performance decay detection process at the box 1204 of FIG. 12 occurring. At conditional step S1304, the processing circuitry 110 determines if an alert exists. If an alert does not exist, at step S1306, the model health score of the method 200 may be released and may be published as described above in 1206.

If an alert does exist, the processing circuitry 110 pauses the prediction system 1200 at S1308. By pausing the prediction system 1200, a prediction and/or model health score may not be published to a log and/or database until the alert is investigated. At step S1310, the processing circuitry 110 may additionally pause push notifications for any alerts generated by the prediction system 1200. For example, any alerts for a runtime model performance decay detection process via email or an instant messaging system may be paused.

After the prediction process and alerting are paused, the alert may be investigated. For example, an incident ticket may be created by the processing circuitry 110 and a data science engineer may be notified. In at least one example embodiment, the data science engineer may be notified by emailing a notification to a designated email. In other embodiments, the data science engineer may be notified by other methods such as, but not limited to, additional messaging systems. At step S1325, the incident ticket may be assigned to an analyst who may collaborate with model owners or other personnel to resolve the incident ticket. Once the incident ticket is resolved, the alert may be cured. Once the alert is cured, at S1314, the alert may be marked as resolved by the processing circuitry 110. Then, at S1316, the modeling process may be re-run starting with S1302. For example, the method 200 may be re-run to determine a model health score for a selected prediction for a selected model. Once the modeling process is re-run at S1316, the method 1300 may proceed back to S1302 where the alert search is re-executed. In at least one example embodiment this process may continue until there are no alerts that exist.

This written description uses examples of the subject matter disclosed to enable any person skilled in the art to practice the same, including making and using any devices, systems, and/or non-transitory computer readable media, and/or performing any incorporated methods. The patentable scope of the subject matter is defined by the claims, and may include other examples that occur to those skilled in the art. Such other examples are intended to be within the scope of the claims.

What is claimed is:

1. A system for generating a model health score, the system comprising:
a memory storing computer-executable instructions and
a processor configured to execute the computer-executable instructions to cause the system to perform,
selecting a model of a plurality of models to analyze, the selected model including a plurality of variables,
selecting a prediction from a plurality of predictions where the selected model was executed, and
determining the model health score for the selected model based on at least a subset of the plurality of variables, the model health score indicating viability of the selected prediction for the selected model.

2. The system of claim 1, wherein the system is further caused to perform:
determining whether expected performance of the selected model has started to decay based on the model health score; and
outputting an alert if the expected performance of the selected model has started to decay.

3. The system of claim 1, wherein
each variable of the plurality of variables has an expected contribution percentage and an expected contribution index for the selected model, and
a sum of the expected contribution indexes of each variable of the plurality of variables is an expected total contribution index.

4. The system of claim 3, wherein the expected contribution index is determined by dividing the expected contribution percentage by an average contribution percentage for the plurality of variables.

5. The system of claim 3, wherein the determining the model health score for the selected model includes:
for each variable of the variables with an expected contribution index above a threshold value,
determining a drift score,
setting a model health score contribution index of the variable as the expected contribution index if the drift score is below a drift score threshold, and
setting the model health score contribution index of the variable to zero if the drift score is above the drift score threshold,
determining a model health score total contribution index as a sum of the model health score contribution indexes; and
determining the model health score by dividing the model health score total contribution index by the expected total contribution index.

6. The system of claim 5, wherein the system is further caused to perform:
obtaining model data for the model on the selected prediction;
dividing the model data into one or more segments; and
determining the drift score for each variable of the plurality of variables within each of the one or more segments.

7. The system of claim 5, wherein the system is further caused to perform:
determining a variable health alert rank for each variable of the plurality of variables; and
sorting the plurality of variables based on the variable health alert rank to determine a variable health rank, wherein the variable health rank indicates a root cause of the model health score.

8. The system of claim 7, wherein the variable health alert rank for a variable of the plurality of variables is determined by
determining a variable health index for the variable;
determining a variable health index drift score for the variable; and
determining a variable health alert rank for the variable based on the variable health index drift score of the variable and a variable health index drift score of each variable of the plurality of variables.

9. The system of claim 1, wherein the system is further caused to perform:
outputting a number of errors of the model on the selected prediction,
wherein the number or errors corresponds to a number of variables with a variable health below a variable health threshold.

10. The system of claim 9, wherein the system is further caused to perform:
outputting a number of warnings of the model on the selected prediction, wherein the variable health threshold is a first threshold and the number or warnings corresponds to a number of variables with a variable health above a second threshold and below the first threshold, the first threshold being greater than the second threshold.

11. The system of claim 1, wherein the system is further caused to perform:
outputting a first indication if the model health score drops below a first threshold; and
outputting a second indication if the model health score drops below a second threshold, the second threshold being less than the first threshold.

12. The system of claim 1, wherein the system is further caused to perform:
generating an aggregate model health score based on the model health score of the selected prediction and a model health score and a lift health score of the selected model on one or more predictions within a range of the selected prediction.

13. The system of claim 1, wherein the system is further caused to perform:
generating a graphical user interface including at least one of the model health score, the model health score over a period of time, or performance information of the plurality of variables of the selected model.

14. A method for generating a model health score, the method comprising:
selecting a model of a plurality of models to analyze, the model including a plurality of variables;
selecting a prediction of a plurality of predictions where the model was executed; and
determining the model health score for the selected model based on at least a subset of the plurality of variables, the model health score indicating viability of the selected prediction for the selected model.

15. The method of claim 14, further comprising:
determining whether expected performance of the selected model has started to decay based on the model health score; and
outputting an alert if the expected performance of the selected model has started to decay.

16. The method of claim 14, wherein
each variable of the plurality of variables has an expected contribution percentage and an expected contribution index for the selected model, and
a sum of the expected contribution indexes of each variable of the plurality of variables is an expected total contribution index.

17. The method of claim 16, wherein the expected contribution index is determined by dividing the expected contribution percentage by an average contribution percentage for the plurality of variables.

18. The method of claim 16, wherein the determining the model health score for the selected model includes:
for each variable of the variables with an expected contribution index above a threshold value,
determining a drift score,
setting a model health score contribution index of the variable as the expected contribution index if the drift score is below a drift score threshold, and
setting the model health score contribution index of the variable to zero if the drift score is above the drift score threshold,
determining a model health score total contribution index as a sum of the model health score contribution indexes; and
determining the model health score by dividing the model health score total contribution index by the expected total contribution index.

19. The method of claim 18, further comprising:
obtaining model data for the model on the selected prediction;
dividing the model data into one or more segments; and
determining the drift score for each variable of the plurality of variables within each of the one or more segments.

20. The method of claim 18, further comprising:
determining a variable health alert rank for each variable of the plurality of variables; and
sorting the plurality of variables based on the variable health alert rank to determine a variable health rank, wherein the variable health rank indicates a root cause of the model health score.

21. The method of claim 20, wherein the variable health alert rank for a variable of the plurality of variables is determined by
determining a variable health index for the variable;
determining a variable health index drift score for the variable; and
determining a variable health alert rank for the variable based on the variable health index drift score of the variable and a variable health index drift score of each variable of the plurality of variables.

22. The method of claim 14, further comprising:
outputting a number of errors of the model on the selected prediction,
wherein the number or errors corresponds to a number of variables with a variable health below a variable health threshold.

23. The method of claim 22, further comprising:
outputting a number of warnings of the model on the selected prediction,
wherein the variable health threshold is a first threshold and the number or warnings corresponds to a number of variables with a variable health above a second threshold and below the first threshold, the first threshold being greater than the second threshold.

24. The method of claim 14, further comprising:
outputting a first indication if the model health score drops below a first threshold; and
outputting a second indication if the model health score drops below a second threshold, the second threshold being less than the first threshold.

25. The method of claim 14, further comprising:
generating an aggregate model health score based on the model health score of the selected prediction and a model health score and a lift health score of the selected model on one or more predictions within a range of the selected prediction.

26. The method of claim 14, further comprising:
generating a graphical user interface including at least one of the model health score, the model health score over a period of time, or performance information of the plurality of variables of the selected model.
